(19) United States
(12) Patent Application Publication
(10) Pub. No.: US 2010/0182115 A1
(43) Pub. Date: Jul. 22, 2010

(54) WIRE WOUND TYPE CHOKE COIL

(75) Inventors: Yi-Min Huang, Hsinchu City (TW); Roger Hsieh, Hsinchu County (TW); Lan-Chin Hsieh, Kaohsiung City (TW); Tsung-Chan Wu, Tainan County (TW)

Correspondence Address: J C PATENTS, 4 VENTURE, SUITE 250, IRVINE, CA, 92618, US

(73) Assignee: CYNTEC CO., LTD., Hsinchu (TW)

(21) Appl. No.: 12/564,245

(22) Filed: Sep. 22, 2009

(30) Foreign Application Priority Data
Jan. 17, 2009 (TW) 98101789

(51) Int. Cl. H01F 27/02

(52) U.S. Cl. 336/83

(57) ABSTRACT

A choke coil including a drum-core and at least one wire is provided. The drum-core includes a pillar, a first board and a second board. Two ends of the pillar are respectively connected to the first board and the second board. A material of the drum-core includes ferrous alloy. The wire has a winding portion wrapped around the pillar.

### CROSS-REFERENCE TO RELATED APPLICATION

This application claims the priority benefit of Taiwan application serial no. 98101789, filed Jan. 17, 2009. The entirety of the above-mentioned patent application is hereby incorporated by reference herein and made a part of specification.

### BACKGROUND OF THE INVENTION

1. Field of the Invention

The present invention relates to a choke coil. More particularly, the present invention relates to a wire wound type choke coil.

2. Description of Related Art

A choke coil is used for stabilizing a circuit current to achieve a noise filtering effect, and a function thereof is similar to that of a capacitor, by which stabilization of the current is adjusted by storing and releasing electrical energy of the circuit. Compared to the capacitor that stores the electrical energy by an electrical field, the choke coil stores the same by a magnetic field. In application of the choke coil, there generally has an energy loss of a wire (which is generally referred to as a copper wire loss) and an energy loss of a core (which is generally referred to as a core loss).

Referring to FIG. 1, a conventional choke coil 100 is generally applied to electronic devices requiring a high saturation current, such as a DC-DC converter of a laptop computer, etc. The choke coil 100 has a magnetic block 120 and a coil 110 embedded in the magnetic block 120. A method of fabricating the choke coil 100 is as follows. First, an automation equipment is applied for winding the coil 110. Next, the coil 110 is disposed in a mold (not shown), and magnetic powders including adhesive are filled into the mold. Then, a pressure molding is performed to the magnetic powders to form the magnetic block 120, so that the coil 110 is totally embedded in the magnetic block 120. Next, a heating temperature below 200° C. is applied to cure the adhesive to form the magnetic block 120. A characteristic of the choke coil 100 is that the coil 110 can be winded by the automation equipment, so that a human labour cost is saved.

However, during the fabrication process of the choke coil 100, to avoid a coil damage due to an excessive heating temperature, the heating temperature has to be lower than 200° C., so that only materials with relatively high core loss (for example, iron powder) can be used as the magnetic powder, and a permeability of the heated magnetic block 120 is relatively low (below 33). Therefore, the choke coil 100 cannot be utilized to electronic devices requiring high inductance and low core loss, such as personal computers, servers or power supplies of workstations, etc.

Referring to FIG. 2A and FIG. 2B, another conventional choke coil 200 has a toroidal core 210 and a wire 220 wrapping around the toroidal core 210. A method of fabricating the choke coil 200 is as follows. First, a pressure molding is performed to magnetic powers (not shown) to form the toroidal core 210. Next, a temperature above 600° C. is applied to sinter the toroidal core 210. Next, the wire 220 is manually wrapped around the toroidal core 210. A characteristic of the choke coil 200 is that it is no need to consider the problem of wire damage caused by the excessive sintering temperature during the sintering process, so that compared to the choke coil 100, the sintering temperature of the choke coil 200 can be increased for more than 600° C. Therefore, materials with relatively low core loss can be used as the magnetic powder, and a permeability of the sintered toroidal core 210 is relatively high (above 60), and accordingly the choke coil 200 can be applied to electronic devices requiring the high inductance (for example, greater than 2 μH) and the low core loss. However, the wire 220 of the choke coil 200 has to be manually wrapped around the toroidal core 210, and automated production of the choke coil 200 cannot be achieved. Therefore, a considerable human labour cost is spent for fabricating the choke coil 200.

### SUMMARY OF THE INVENTION

The present invention is directed to a wire wound type choke coil with a relatively low core loss.

The present invention is directed to a wire wound type choke coil, which has a relatively low human labour cost during a fabrication process thereof.

The present invention provides a wire wound type choke coil including a drum-core and at least one wire. The drum-core includes a pillar, a first board and a second board. Two ends of the pillar are respectively connected to the first board and the second board. A material of the drum-core includes ferrous alloy. The wire has a winding portion wrapped around the pillar. Since the core of the present invention is a drum-core, the wire can be wrapped around the pillar of the drum-core by an automation equipment, so as to effectively reduce a human labour cost during a winding process of the wire.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a conventional choke coil.

FIG. 2A is a top view of a conventional choke coil.

FIG. 2B is a cross-sectional view of a toroidal core of FIG. 2A along an I-I′ line.

FIG. 3 is a cross-sectional view of a choke coil according to an embodiment of the present invention.

FIG. 4A and FIG. 4B are diagrams respectively illustrating saturation characteristic curves of choke coils having drum-cores of No. 15×16 and 18×14.65.

FIG. 5A and FIG. 5B are diagrams respectively illustrating core loss curves of choke coils having drum-cores of No. 15×16 and 18×14.65.

FIG. 6A, FIG. 6B, FIG. 6C and FIG. 6D are diagrams respectively illustrating saturation characteristic curves of choke coils having drum-cores of No. 10×12.75, 11×12.25, 12×12.25 and 14×14.25.

FIG. 7A, FIG. 7B, FIG. 7C and FIG. 7D are diagrams respectively illustrating core loss curves of choke coils having drum-cores of No. 10×12.75, 11×12.25, 12×12.25 and 14×14.25.

FIG. 8 is a diagram illustrating measured efficiency curves of a choke coil of an embodiment of the present invention and a conventional choke coil.

FIG. 9 and FIG. 10 are diagrams illustrating two structure variations of a choke coil of FIG. 3.

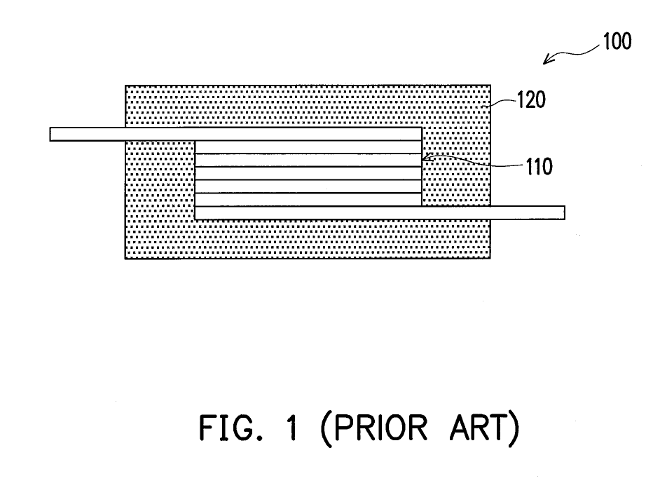

### DESCRIPTION OF EMBODIMENTS

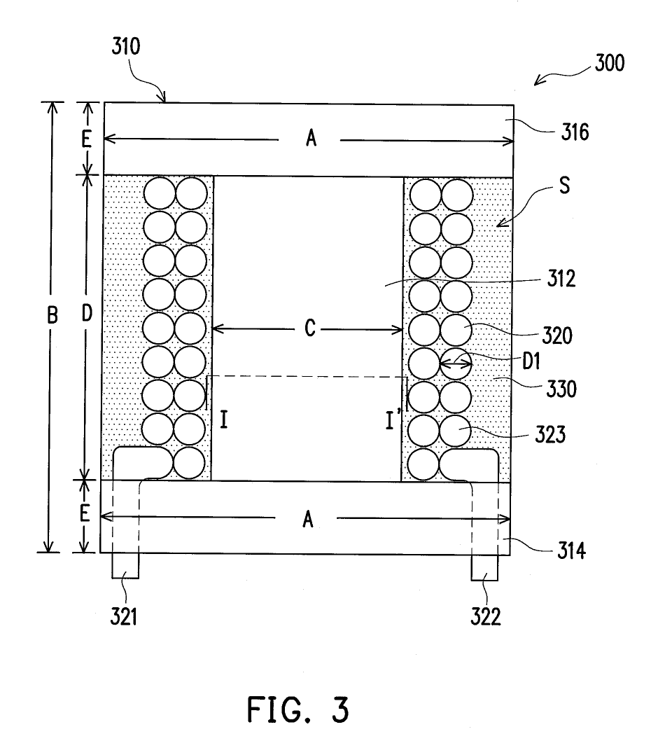

Referring to FIG. 3, a wire wound type choke coil 300 according to an embodiment of the present invention includes a drum-core 310 and a wire 320. The drum-core 310 includes a pillar 312, a first board 314 and a second board 316, wherein two ends of the pillar 312 are respectively connected to the first board 314 and the second board 316. A material of the drum-core 310 is ferrous alloy which can be FeAlSi alloy, FeNiMo alloy, FeNi alloy or amorphous alloy. The drum-core 310 is formed by molding the material comprising magnetic powders, and then sintering the powders by a temperature above 300° C., and a preferred sintering temperature is above 600° C. A permeability of the drum-core 310 is, for example, 60 to 300, and is preferably 60 to 125. The permeability is defined as a ratio between a magnetic flux density (B) and a magnetic field strength (H) of a magnetization curve when a magnetic field strength (H) is closed to zero, which applies a cgs system. In the present embodiment, the first board 314 and the second board 316 are two round boards, and the pillar 312 is a cylinder, though the present invention is not limited thereto, and in other embodiments, the first board 314 and the second board 316 can be two rectangular boards, and the pillar 312 can be a polygonal column. A winding space S is formed among the first board 314, the second board 316 and the pillar 312.

The wire 320 is located in the winding space S, and wraps around the pillar 312 of the drum-core 310. A material of the wire 320 can be copper, and the wire 320 can be a round wire or a flat wire. To be specific, the wire 320 has two end portions 321 and 322, and a winding portion 323 located between the two end portions 321 and 322, wherein the winding portion 323 wraps around the pillar 312, and the two end portions 321 and 322 extend from inside of the winding space S to outside of the winding space S. The winding portion 323 wraps around the pillar 312 for one turn or more than one turn. When the winding portion 323 wraps around the pillar 312 for more than one turns, an outer surface of the wire 320 can be coated by an insulating material. The two end portions 321 and 322 can be directly served as external electrodes, or can be connected to a lead frame to serve as the external electrodes. The external electrodes can be electrically connected to an external circuit through an approach of a through-hole mount or a surface mount. Moreover, the wire 320 can be wrapped around the pillar 312 by an automation equipment, or can be first winded into a hollow coil (not shown) by the automation equipment, and then the pillar 312 passes through the hollow coil. Moreover, a quantity of the wire 320 is not limited by the present embodiment. In other words, the quantity of the wire 320 can be one or more.

In addition, a magnetic material 330 or a resin material with a permeability of, for example, 1 (not shown) can be selectively filled in the winding space S between the first board 314 and the second board 316, so as to fill the winding space S and encapsulate the winding portion 323 and a part of the end portions 321 and 322, wherein the unencapsulated part of the end portions are used for electrically connecting to the external circuit. The magnetic material 330 includes a resin material and a magnetic powder material, and a permeability thereof is, for example, 5 to 10, though the present invention is not limited thereto. The resin material can be one of polyamide 6 (PA6), polyamide 12 (PA12), polyphenylene sulfide (PPS), polybutyleneterephthalate (PBT), and ethylene-ethyl acrylate copolymer (EEA). The magnetic powder material can be a metal soft magnetic material or ferrite, wherein the metal soft magnetic material can be one of iron, FeAlSi alloy, FeCrSi alloy and stainless steel.

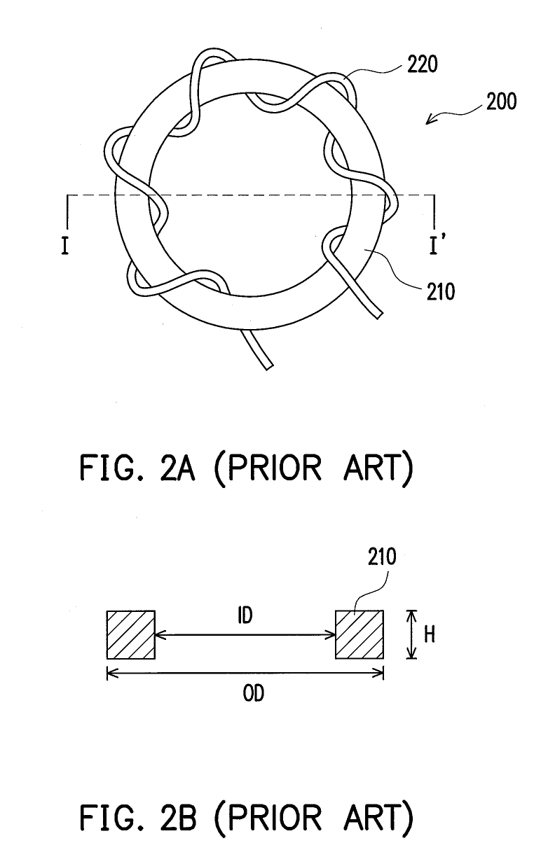

In the following content, saturation characteristics and core losses of the choke coil 200 of FIG. 2A and the choke coil 300 of the present embodiment are simulated and measured based on conditions of the same core material, similar inductance, similar copper wire loss and similar size. Therefore, the saturation characteristics and core losses of the two choke coils 300 and 200 can be compared in case that the material cost of the drum-core 310 is similar to that of the toroidal core 210.

First, calculation methods for physical quantities of the toroidal core 210 are provided. Referring to FIG. 2A and FIG. 2B, the toroidal core 210 has an outer diameter OD (unit: mm), an inner diameter ID (unit: mm) and a thickness H (unit: mm), and an effective magnetic path length of the toroidal core 210 is Le1 (unit: mm), an effective area thereof is Ae1 (unit: mm²), an effective volume thereof is Ve1 (unit: mm³), and Le1, Ae1 and Ve1 are respectively represented by following equations 1, 2 and 3:

$$\begin{matrix}Le 1 = \frac{( OD + ID )}{2} \times π & ( equation 1 ) \\ A e 1 = \frac{( OD - ID )}{2} \times H & ( equation 2 ) \\ V e 1 = A e \times L e & ( equation 3 )\end{matrix}$$

If the winding turns of the wire 220 is N1, and an input current is I1 (unit: A), an inductance of the choke coil 200 is L1 (unit: Herry), and a generated magnetic field is H1 (unit: A/mm), wherein L1 and H1 can be represented by equations 4 and 5, wherein μ1 represents the permeability of the toroidal core 210:

$$\begin{matrix}L 1 = \frac{N {1}^{2} \times μ 1 \times A e 1}{L e 1} & ( equation 4 ) \\ H 1 = \frac{N 1 \times I 1}{L e 1} & ( equation 5 )\end{matrix}$$

Next, calculation methods for physical quantities of the drum-core 310 are provided. Referring to FIG. 3, the first board 314 and the second board 316 has the same a first diameter A and a first thickness E, the pillar 312 has a second diameter C and a second thickness D, wherein the second diameter C is less than the first diameter A. If the first and the second boards 314 and 316 are round boards, the first diameter A is a diameter of a circular cross section of the round board, and if the first and the second boards 314 and 316 are rectangular boards, the first diameter A is a length of the longest side of a rectangular cross section of the rectangular board. The drum-core 310 further has an effective area Ae and an equivalent magnetic path length Le, and the effective area Ae can be represented by a following equation 6:

$$A e = {( \frac{C}{2} )}^{2} \times π \qquad ( equation 6 )$$

Parameters of the drum-core 310 can be deduced according to the equations 1-5. According to the equation 4, the inductance L1 is inversely proportional to the equivalent magnetic path length Le1, so that a relation among the equivalent magnetic path length Le of the drum-core 310 and Le1, L1 and L can be represented by a equation 7, wherein N represents the winding turns of the wire 320, and L represents the inductance of the choke coil 300:

$$L e = \frac{N {1}^{2} \times μ 1 \times A e 1}{L 1} \times \frac{L 1}{L} \times \frac{N {1}^{2} \times μ 1 \times A e 1}{L} \qquad ( equation 7 )$$

In the present embodiment, by measuring the inductance L of the choke coil 300, and inputting it to the equation 7, the equivalent magnetic path length Le can be obtained. Various results of related size parameters (A, E, C and D) of the drum-core 310 and the winding turns N of the wire 320 can be obtained through a simulation software in case that the inductance L, the copper wire loss, and the size of the choke coil 300 is similar to those of the choke coil 200. In the present embodiment, the first diameter A is substantially 6.6 mm to 23 mm, the first thickness E is substantially 0.5 mm to 2.5 mm, the second diameter C is substantially 2.2 mm to 9 mm, and the second thickness D of the pillar 312 is substantially 1.8 mm to 16.4 mm. A half of a difference between the first diameter A and the second diameter C is, for example, 2.2 mm to 8 mm. A ratio of the first diameter A to the second diameter C is, for example, 2 to 3. A ratio of the second thickness D to the first thickness E is, for example, 3 to 7. A total thickness B of the choke coil 300 (i.e. a sum of the first thickness and two second thicknesses) is, for example, 2.8 mm to 21.4 mm.

Moreover, since the following simulation and the measurement results relate to the copper wire loss and the core loss, a related ripple theory and a related core loss theory of an alternating-current (AC) circuit of the choke coil are first introduced. In the AC circuit, a current variation ΔI generated by the ripple can be represented by an equation 8, wherein Vin represents an input voltage (unit: V) input in the choke coil, Vout represents a corresponding output voltage output from the choke coil, L represents an inductance of the choke coil, and f represents a frequency of the AC signal (unit: Hz):

$$Δ I = \frac{( Vin - Vout )}{L} \times \frac{( Vout / Vin )}{f} \qquad ( equation 8 )$$

According to the equation 8, it is known that L is inversely proportional to ΔI. In other words, the greater the inductance of the choke coil is, the smaller the current variation generated by the ripple is, and the more stable the circuit current is.

Now, a magnetic flux density variation ΔB and the core loss of the choke coil can be respectively represented by equations 9 and 10, wherein Cm, x, y are core loss constants of the material itself, and Ve represents an effective volume of the choke coil:

$$\begin{matrix}Δ B = \frac{L \times Δ I}{N \times Ae} & ( equation 9 ) \\ Core loss = Cm \times {f}^{x} \times {( Δ B / 2 )}^{y} \times V e & ( equation 10 )\end{matrix}$$

It should be noted that in the following simulation results, for simplicity's sake, the drum-core 310 is briefly referred to as DR-Core, and A, B, C, D, E respectively represent the first diameter, the total thickness of the choke coil, the second diameter, the second thickness and the first thickness, Ae represents the effective area of the drum-core 310, μ represents the permeability of the magnetic material 330, and Le represents the equivalent magnetic path length of the choke coil 300. A coil design is represented by “wire diameter-winding turns”. For example, 1.2 mm-14.5 T represents that the wire 320 with the wire diameter of 1.2 mm winds the pillar 312 for 14.5 turns. DCR represents a coil impedance of the wire 320. Moreover, the conventional toroidal core 210 is briefly referred to as T-Core.

### First Simulation Results

The simulation results show the saturation characteristics and the core losses of the choke coils that convert the voltage from 12 volts to 5 volts. In the present embodiment, various parameters of the choke coil 200 used for comparison are described as follows. Referring to FIG. 2A and FIG. 2B, the outer diameter OD of the toroidal core 210 is 20.64 mm, the inner diameter ID is 12.65 mm, the thickness H is 6.7 mm. The coil design is that two groups of the copper wires with the wire diameter of 1.0 mm wind the pillar for 20 turns. The coil impedance is 5.74 milliohms. The effective magnetic path length Le1 is 52.29 mm. The effective area Ae1 is 26.77 mm². The effective volume Ve1 is 1399.80 mm³. The material of the toroidal core 210 is FeSiAl alloy with the permeability of 75. In the present embodiment, two different size drum-cores 310 are applied, and the material of the drum-cores 310 is FeSiAl alloy with the permeability of 75. Parameters of the two drum-cores 310, the magnetic materials, the coil designs and the coil impedances, etc. are shown in a table 1.

TABLE 1

| | | | | Permeability of | | | | |
|---|---|---|---|---|---|---|---|---|
| | | DR-Core | | magnetic material | | | | |
| DR-Core | | volume | Ae | vs. Le (mm) | | | Coil | DCR |
| No. | A/B/C/D/E (mm) | (mm³) | (mm²) | μ = 1 | μ = 5 | μ = 10 | design | (mΩ) |
| 15 × 16 | 15/16/7/11/2.5 | 129 | 38.4 | 71.5 | 53.6 | 44.5 | 1.2 m-14.5 | 5.6 |
| 18 × 14.6 | 18/14.65/9/9.65/2.5 | 187 | 63.6 | 85.5 | 59.3 | 46.1 | 1.2 m-12.5 | 6.3 |

According to the table 1, it is known that each of the drum-cores 310 applies the resin material with the permeability of 1, and the magnetic materials with the permeability of 5 and 10. In the present embodiment, characteristic curves of the choke coils 300 having the drum-cores 310 of the same size are illustrated in a same curve diagram.

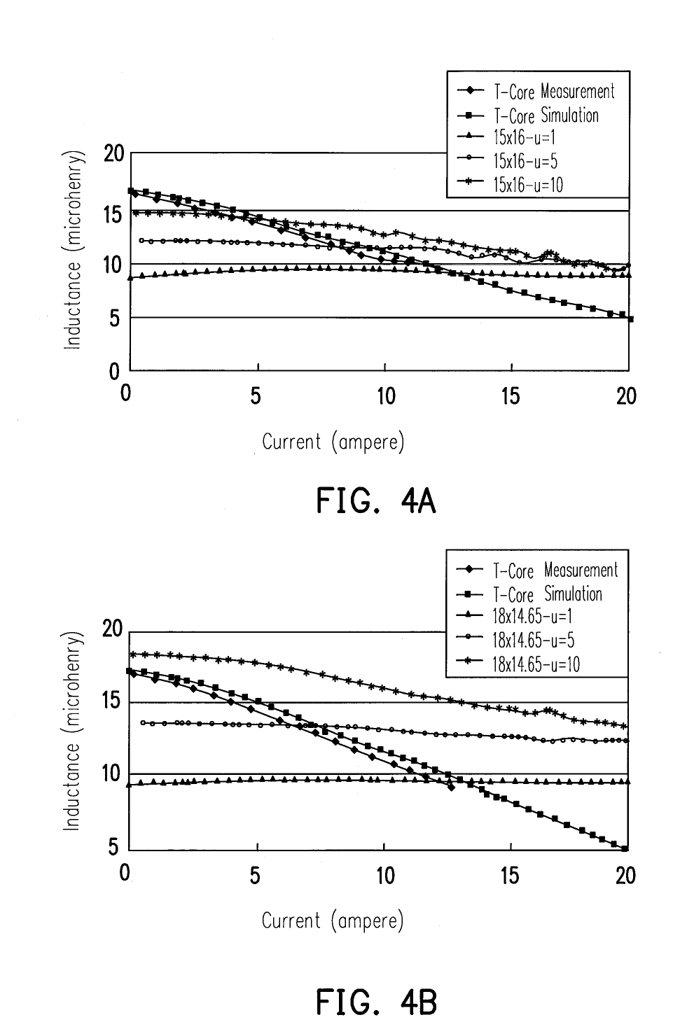

FIG. 4A and FIG. 4B are diagrams respectively illustrating simulation saturation characteristic curves of choke coils having drum-cores of No. 15×16 and 18×14.65 and the choke coil having the toroidal core (T-Core). According to FIG. 4A and FIG. 4B, an initial inductance of the choke coil 300 (i.e. an inductance of the choke coil 300 obtained under a current of 0.001 A) is above 5 μH, and the inductance is decreased as the current is increased. An inductance decreasing speed of the choke coil 300 is less than that of the choke coil 200, so that the saturation characteristic of the choke coil 300 is better than the choke coil 200. Moreover, when the current is increased to more than 13A, the inductance of the choke coil 300 is greater than that of the choke coil 200. Accordingly, the choke coil 300 can maintain a relatively great inductance under a high current. Therefore, in case of the high current, since the choke coil 300 has the relatively great inductance, the current variation generated by the ripple can be reduced, which avails maintaining a current stability.

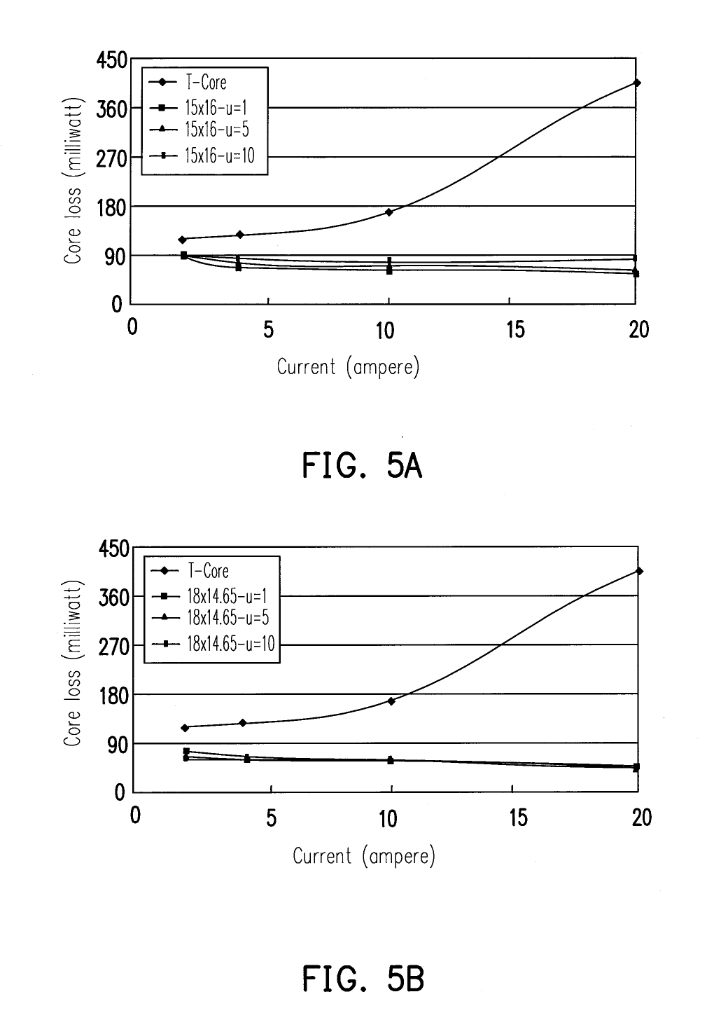

FIG. 5A and FIG. 5B are diagrams respectively illustrating simulation core loss curves of choke coils having drum-cores of No. 15×16 and 18×14.65. Moreover, the measured core loss curves of the choke coil 200 having the toroidal core are further illustrated in FIG. 5A and FIG. 5B. According to FIG. 5A and FIG. 5B, the core loss of the choke coil 200 is greatly increased as the current is increased, while the core loss of the choke coil 300 is less influenced as the current is increased. Moreover, in case of the same input current, the core loss of the choke coil 300 is less than that of the choke coil 200.

### Second Simulation Results

The simulation results show the saturation characteristics and the core losses of the choke coils that convert the voltage from 12 volts to 3.3 volts.

In the present embodiment, various parameters of the choke coil 200 used for comparison are described as follows. Referring to FIG. 2A and FIG. 2B, the outer diameter OD of the toroidal core 210 is 13.17 mm, the inner diameter ID is 7.08 mm, the thickness H is 5.25 mm. The coil design is that a copper wire with the wire diameter of 0.8 mm winds the pillar for 22 turns. The coil impedance is 14.33 milliohms. The effective magnetic path length Le1 is 31.81 mm. The effective area Ae1 is 15.96 mm². The effective volume Ve1 is 507.68 mm³. The material of the toroidal core 210 is FeSiAl alloy with the permeability of 125.

In the present embodiment, four different size drum-cores 310 are applied, and the material of the drum-cores 310 is FeSiAl alloy with the permeability of 125. Parameters of the four drum-cores 310, the magnetic materials, the coil designs and the coil impedances, etc. are shown in a table 2.

TABLE 2

| | | | | Permeability of | | | | |
|---|---|---|---|---|---|---|---|---|
| | | DR-Core | | magnetic material | | | | |
| DR-Core | | volume | Ae | vs. Le (mm) | | | | DCR |
| No. | A/B/C/D/E (mm) | (mm³) | (mm²) | μ = 1 | μ = 5 | μ = 10 | Coil design | (mΩ) |
| 10 × 12.75 | 10/12.75/5/8.25/2.25 | 510 | 19.63 | 64.8 | 49.3 | 39.6 | 0.7 mm-18.5 T | 15.3 |
| 11 × 12.25 | 11/12.25/5.5/8.25/2 | 570 | 23.76 | 69.7 | 50.8 | 39.5 | 0.7 mm-18.5 T | 16.83 |
| 12 × 12.25 | 12/12.25/6/8.25/2 | 678 | 28.74 | 74.1 | 50.8 | 38.6 | 0.7 mm-18.5 T | 18.36 |
| 14 × 14.25 | 14/14.25/6/10.25/2 | 896 | 28.27 | 70.5 | 47.9 | 37.0 | 0.9 mm-18.5 T | 13.04 |

According to the table 2, it is known that each of the drum-cores 310 applies the magnetic materials with the permeability of 1, 5 and 10. In the present embodiment, characteristic curves of the choke coils 300 having the drum-cores 310 of the same size are illustrated in a same curve diagram.

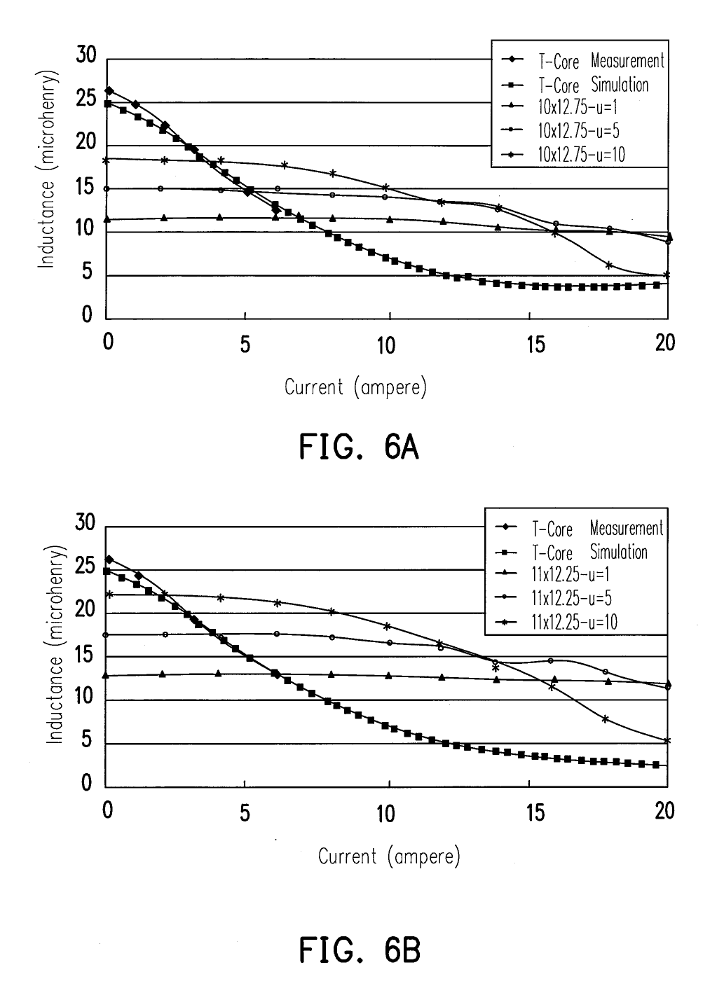

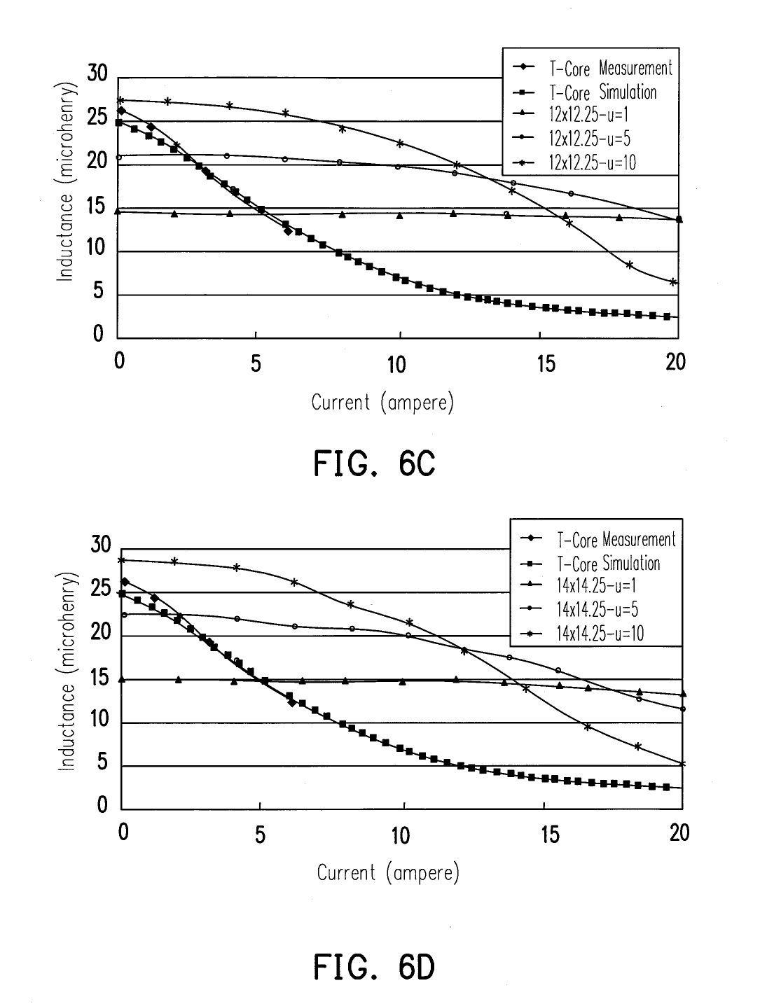

FIG. 6A, FIG. 6B, FIG. 6C and FIG. 6D are diagrams respectively illustrating simulation saturation characteristic curves of choke coils having drum-cores of No. 10×12.75, 11×12.25, 12×12.25 and 14×14.25 and the choke coil having the toroidal core. According to FIGS. 6A-6D, an initial inductance of the choke coil 300 is above 10 μH, and as the current is increased, an inductance decreasing speed of the choke coil 300 is less than that of the choke coil 200, so that the saturation characteristic of the choke coil 300 is better than the choke coil 200. Moreover, when the current is increased to more than 7A, the inductance of the choke coil 300 is greater than that of the choke coil 200. Accordingly, the choke coil 300 can maintain a relatively great inductance under a high current.

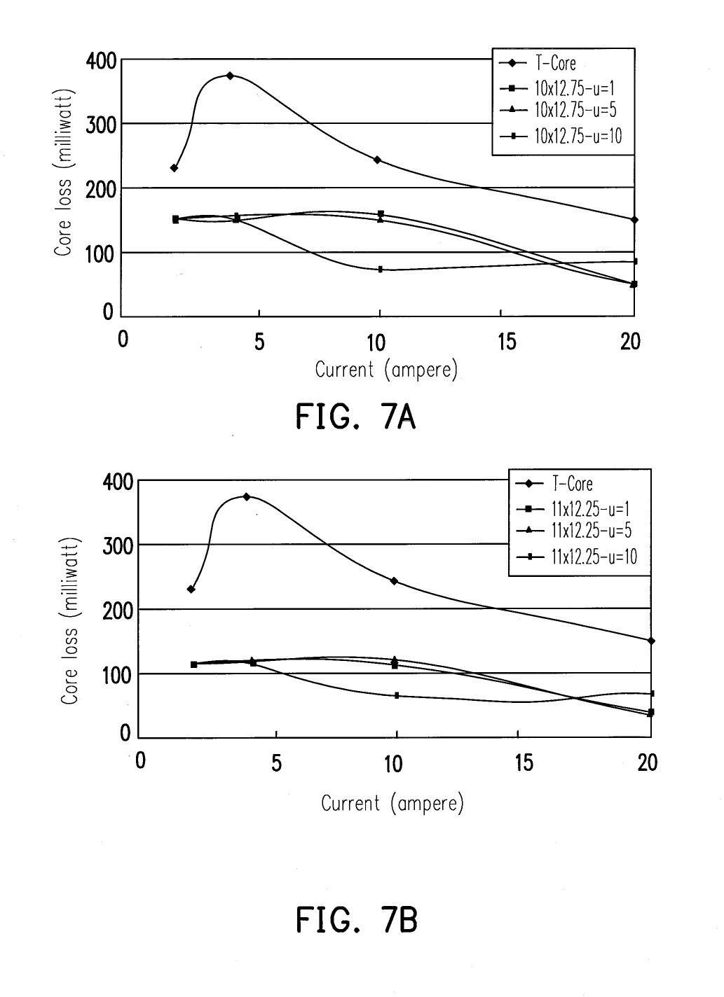

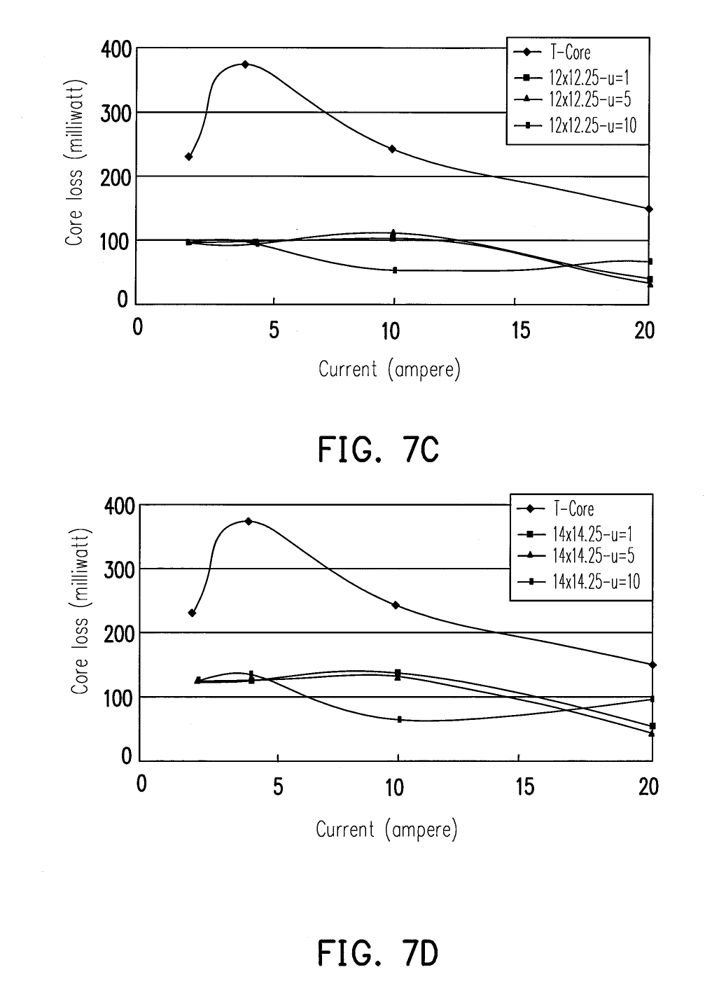

FIG. 7A, FIG. 7B, FIG. 7C and FIG. 7D are diagrams respectively illustrating simulation core loss curves of chokes having drum-cores of No. 10×12.75, 11×12.25, 12×12.25 and 14×14.25. Moreover, the measured core loss curves of the choke coil having the toroidal core are further illustrated in FIGS. 7A-7D. According to FIGS. 7A-7D, in case of the same input current, the core loss of the drum-core of the choke coil 300 is less than that of the toroidal core of the choke coil 200, and the influence of the current variation on the core loss of the drum-core of the choke coil 300 is relatively small.

### Third Simulation Results

The simulation results show the saturation characteristics and the core losses of the choke coils that bear a high current of 70 A and have a high inductance (2.2 μH).

The outer diameter OD of the toroidal core 210 used for comparison is 18 mm, the inner diameter ID is 8 mm, the thickness H is 10.2 mm. The coil design is that six groups of the copper wire with the wire diameter of 1 mm wind the pillar for 3 turns. The material of the toroidal core 210 is FeSiAl alloy with the permeability of 75. Parameters of the drum-core 310, the magnetic material, the coil design and the coil impedance, etc. are shown in a table 3. The material of the drum-core 310 is FeSiAl alloy with the permeability of 75. In the present embodiment, a flat wire is applied, and the coil design is “length×width of a cross section of the flat wire−winding turns”.

TABLE 3

| | | | | Le (mm) in | | |
|---|---|---|---|---|---|---|
| | | | | case a | | |
| | | DR-Core | | permeability of | | |
| DR-Core | A/B/C/D/E | volume | Ae | magnetic | | DCR |
| No. | (mm) | (mm³) | (mm²) | material μ = 5 | Coil design | (mΩ) |
| 18 × 16 | 18/16/7/11/2.5 | 1684 | 38.48 | 42.51 | 3.4 × 1.6-5.5 T | 0.62 |

The saturation characteristics of the choke coil 300 and the choke coil 200 are listed in a table 4.

TABLE 4

Choke coil

| | |
|---|---|
| Conventional | Present embodiment |
| (T-Core) | (DR-Core) |

| | |
|---|---|
| Current (A) | Inductance (μH) |

| | | |
|---|---|---|
| 0.001 | 2.27 | 2.2 |
| 10 | 2.2 | 2.2 |
| 20 | 2.08 | 2.15 |
| 50 | 1.59 | 1.72 |
| 70 | 1.25 | 1.3 |

According to the table 4, it is known that an initial inductance of the choke coil 300 is above 2 μH, and as the current is increased, the choke coil 300 can still maintain a relatively high inductance, so that the saturation characteristic of the choke coil 300 is better than the choke coil 200.

The core losses of the choke coil 300 and the choke coil 200 are listed in a table 5.

TABLE 5

| | Input current | | | |
|---|---|---|---|---|
| | 10 A | 20 A | 50 A | 70 A |
| Core | Core Loss (mW) | | | |
| Conventional (T-Core) | 798.66 | 896.86 | 1160.32 | 1404.95 |
| Present embodiment | 739.41 | 775.3 | 492.94 | 440.54 |
| (DR-Core) | | | | |

According to the table 5, it is known that in case of the same input current, the core loss of the drum-core 310 of the choke coil 300 is less than that of the toroidal core 210 of the choke coil 200, and the core loss of the drum-core 310 is less influenced by the current variation.

### Fourth Simulation Results

The simulation results show the saturation characteristics and the core losses of the choke coils having a high inductance (4.701).

The outer diameter OD of the toroidal core 210 used for comparison is 3 mm, the inner diameter ID is 2 mm, the thickness H is 2 mm. The coil design is that a copper wire with the wire diameter of 0.35 mm winds the pillar for 15 turns. The material of the toroidal core 210 is FeSiAl alloy with the permeability of 75. Parameters of the drum-core 310, the magnetic material, the coil design and the coil impedance, etc. are shown in a following table 6. The material of the drum-core 310 is FeSiAl alloy with the permeability of 75.

TABLE 6

| | | | | Le (mm) in | | |
|---|---|---|---|---|---|---|
| | | | | case a | | |
| | | | | permeability | | |
| | | DR-Core | | of magnetic | | |
| DR-Core | | volume | Ae | material | | DCR |
| No. | A/B/C/D/E (mm) | (mm³) | (mm²) | μ = 6 | Coil design | (mΩ) |
| 6.6 × 2.8 | 6.6/2.8/2.2/1.8/0.5 | 40.2 | 3.8 | 32.61 | 0.35 mm-12.5 T | 30 |

The saturation characteristics of the choke coil 300 and the choke coil 200 are listed in a table 7.

TABLE 7

Choke Coil

| | |
|---|---|
| Conventional | Present embodiment |
| (T-Core) | (DR-Core) |

| | |
|---|---|
| Current (A) | Inductance (μH) |

| | | |
|---|---|---|
| 0.001 | 4.77 | 5.18 |
| 2 | 4.33 | 4.86 |
| 4 | 3.68 | 4.21 |
| 5 | 3.33 | 3.89 |
| 6 | 2.96 | 3.57 |

According to the table 7, it is known that an initial inductance of the choke coil 300 is above 5 μH, and as the current is increased, the choke coil 300 can still maintain a relatively high inductance, so that the saturation characteristic of the choke coil 300 is better than the choke coil 200.

The core losses of the choke coil 300 and the choke coil 200 are listed in a table 8.

TABLE 8

Input current

| | | | |
|---|---|---|---|
| 2 A | 4 A | 5 A | 6 A |

| | |
|---|---|
| Core | Core Loss (mW) |

| | | | | |
|---|---|---|---|---|
| Conventional (T-Core) | 86 | 120.3 | 147.9 | 188.7 |
| Present embodiment | 45.3 | 68.7 | 70.1 | 70.1 |
| (DR-Core) | | | | |

According to the table 8, it is known that in case of the same input current, the core loss of the drum-core 310 of the choke coil 300 is less than that of the toroidal core 210 of the choke coil 200, and the core loss of the drum-core 310 is less influenced by the current variation.

### Measured Results

The measured results show the saturation characteristics and the core losses of the choke coils that convert the voltage from 12 volts to 5 volts.

In the present embodiment, various parameters of the choke coil 200 used for comparison are described as follows. Referring to FIG. 2A and FIG. 2B, the outer diameter OD of the toroidal core 210 is 17.6 mm, the inner diameter ID is 9.5 mm, the thickness H is 6.8 mm. The coil design is that three group of the copper wire with the wire diameter of 0.8 mm winds the pillar for 8.5 turns. The coil impedance is 2.57 milliohms. The effective magnetic path length Le1 is 42.71 mm. The effective area Ae1 is 27.85 mm². The effective volume Ve1 is 1190 mm³. The material of the toroidal core 210 is FeSiAl alloy with the permeability of 125.

In the present embodiment, the drum-core 310 (DR-Core) with one size is applied, and the material of the drum-core 310 is FeSiAl alloy with the permeability of 75. Parameters of such drum-core 310, the magnetic material, the coil design and the coil impedance, etc. are listed in a table 9.

TABLE 9

| | | | | Le (mm) in | | |
|---|---|---|---|---|---|---|
| | | | | case a | | |
| | | DR-Core | | permeability | | |
| DR-Core | A/B/C/D/E | volume | Ae | of magnetic | | DCR |
| No. | (mm) | (mm³) | (mm²) | material μ = 6 | Coil design | (mΩ) |
| 15 × 16 | 15 × 16/5/11/2.5 | 1092 | 19.63 | 32.61 | 1.4 mm-12.5 T | 3.86 |

The saturation characteristics of the choke coil 300 and the choke coil 200 are listed in a table 10.

TABLE 10

Choke Coil

| | |
|---|---|
| Conventional | Present embodiment |
| (T-Core) | (DR-Core) |

| | |
|---|---|
| Current (A) | Inductance (μH) |

| | | |
|---|---|---|
| 0.001 | 7.143 | 7.558 |
| 2 | 6.791 | 7.472 |
| 4 | 6.314 | 7.324 |
| 10 | 4.586 | 6.714 |
| 20 | 2.398 | 4.890 |

According to the table 10, it is known that an initial inductance of the choke coil 300 is above 7 μH, and as the current is increased, an inductance decreasing speed of the choke coil 300 is less than that of the choke coil 200, so that the saturation characteristic of the choke coil 300 is better. Moreover, in case of the same input current, the inductance of the choke coil 300 is greater than that of the choke coil 200. Therefore, the measured result of the saturation characteristic of the choke coil is similar to the simulation results of the saturation characteristics of the primary two groups of the choke coils.

The core losses of the choke coil 300 and the choke coil 200 are listed in a table 11.

TABLE 11

Input current

| | 2 A | 4 A | 10 A | 20 A |
|---|---|---|---|---|
| Core | Core Loss (mW) | | | |
| Conventional (T-Core) | 448.0 | 518.0 | 980.4 | 2213.9 |
| Present embodiment | 365.8 | 381.3 | 430.2 | 257.4 |
| (DR-Core) | | | | |

According to the table 11, it is known that in case of the same input current, the core loss of the drum-core 310 of the choke coil 300 is less than that of the toroidal core 210 of the choke coil 200, and the core loss of drum-core 310 is less influenced by the current variation. According to the above description, the measured result of the core loss of the choke coil is similar to the simulation results of the core loss of the primary three groups of the choke coils.

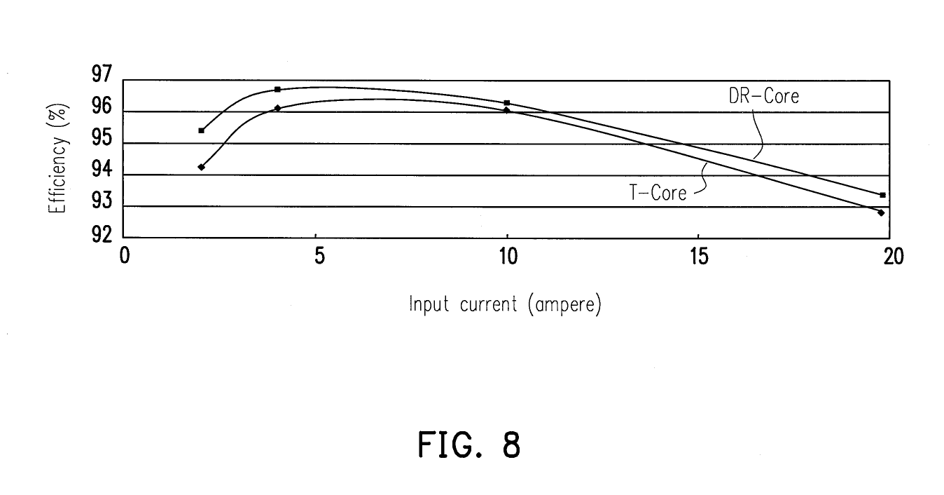

FIG. 8 is a diagram illustrating measured efficiency curves of a choke coil of an embodiment of the present invention and the choke coil 200. The efficiency of the choke coil can be represented by a following equation 11, wherein Vin represents an input voltage, Vout represents an output voltage, Iin represents an input current, and Iout represents an output current.

$$Efficiency = \frac{Vout \times Iout}{Vin + \times Iin} \qquad ( equation 11 )$$

According to FIG. 8, it is known that in case of the same input current, the efficiency of the choke coil 300 is greater than that of the choke coil 200.

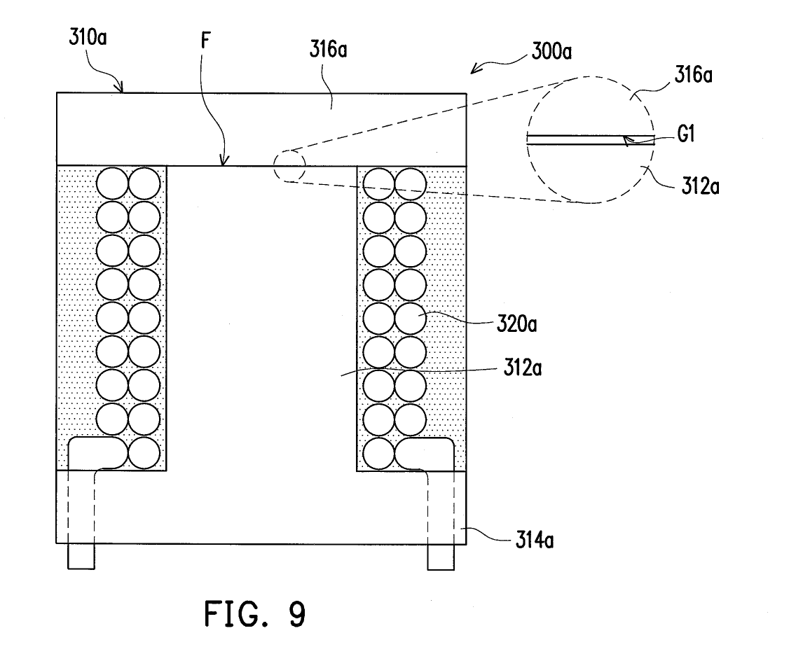

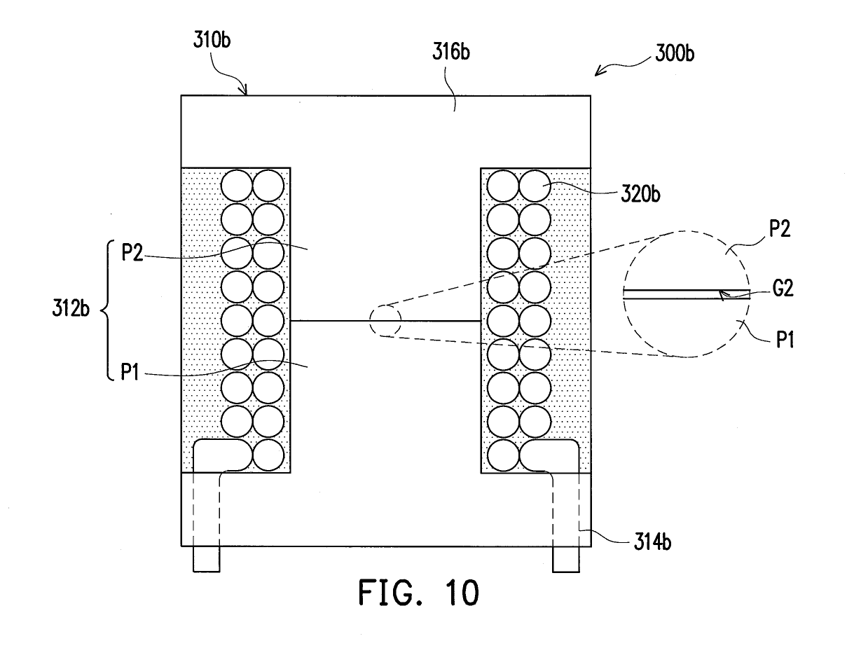

FIG. 9 and FIG. 10 are diagrams illustrating two structure variations of the choke coil of FIG. 3. If the wire diameter of the wire is relatively great, the wire cannot be directed winded on the pillar. Therefore, the wire can be first winded into a coil by an automation equipment, and then the pillar passes through the coil. Referring to FIG. 9, in the present embodiment, a pillar 312a and a first board 314a of a drum-core 310a of a choke coil 300a are formed integrally, while the pillar 312a and a second board 316a are respectively formed. Therefore, the pillar 312a can first passes through the winded wire 320a, and then the second board 316a is bonded to an end F of the pillar 312a via adhesion or other methods (for example, welding). In case of the adhesion, epoxy resins or magnetic plastics can be applied. Moreover, since the pillar 312a and the second board 316a are respectively formed, a bonding layer (for example, a gap G1) is probably formed between the pillar 312a and the second board 316a. In a table 12, the inductances of the choke coil 300a influenced by different sizes of the gap G1 are listed.

TABLE 12

| | Inductance (uH) | Inductance difference |
|---|---|---|
| G1 = 0 um | 13.29 | 0% |
| G1 = 50 um | 12.98 | −2.33% |
| G1 = 100 um | 12.95 | −2.56% |

According to the table 12, it is known that as long as a height of the gap G1 between the pillar 312a and the second board 316a of the choke coil 300a is controlled to be less than 100 micrometers, a difference between the inductance of the choke coil 300a and the inductance of the non-gap choke coil 300 can be maintained within 5%.

Moreover, referring to FIG. 10, in the present embodiment, a pillar 312b of a drum-core 310b of a choke coil 300b has mutually independent a first part P1 and a second part P2, wherein the first part P1 and a first board 314b are formed integrally, and the second part P2 and a second board 316b are formed integrally. Therefore, the first part P1 (or the second part P2) can first passes through a winded wire 320b, and then the second part P2 is bonded to the first part P1 via adhesion or other methods (for example, welding). In case of the adhesion, epoxy resins or magnetic plastics can be applied. Moreover, since the first part P1 and the second part P2 are mutually independent, a bonding layer (for example, a gap G2) is probably formed between the first part P1 and the second part P2. In a table 13, the inductances of the choke coil 300b influenced by different sizes of the gap G2 are listed.

TABLE 13

| | Inductance (uH) | Inductance difference |
|---|---|---|
| G2 = 0 um | 13.29 | 0% |
| G2 = 50 um | 12.5 | −5.94% |
| G2 = 100 um | 11.62 | −12.57% |

According to the table 13, it is known that as long as a height of the gap G2 between the first part P1 and the second part P2 of the choke coil 300b is controlled to be less than 50 micrometers, a difference between the inductance of the choke coil 300b and an inductance of a non-gap choke coil can be maintained within 10%.

In summary, since the choke coil of the present invention applies the drum-core, and the material of the drum-core is ferrous alloy, the present invention has at least the following advantages:

1. In the present invention, the wire can be winded on the pillar of the drum-core by an automation equipment, so as to effectively reduce a human labour cost of the winding process of the wire.

2. When a current is increased, an inductance decreasing speed of the choke coil of the present invention is less than that of the conventional choke coil, so that the saturation characteristic of the choke coil of the present invention is better.

3. Since the choke coil of the present invention can maintain a relatively great inductance under a high current, the choke coil of the present invention can effectively reduce a current variation generated by the ripple produced by the high current, which avails maintaining a current stability.

4. The core loss of the choke coil of the present invention is less influenced as the current is increased, and in case of the same input current, the core loss of the choke coil of the present invention is less than that of the conventional choke coil.

5. The efficiency of the choke coil of the present invention is greater than that of the conventional choke coil.

6. The choke coil of the present invention can provide an inductance above 2 μH.

7. In the choke coil of the present invention, the drum-core is first formed, and then the wire is winded on the drum-core, so that a problem of wire damage due to an excessive sintering temperature can be avoided, and a fabrication material of the wire is unnecessarily to be a high temperature resistant material with a high cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wire wound type choke coil, comprising:
a drum-core, comprising a pillar, a first board and a second board, wherein two ends of the pillar are respectively connected to the first board and the second board, and a material of the drum-core comprises ferrous alloy; and
at least one wire, having a winding portion wrapped around the pillar.

2. The choke coil as claimed in claim 1, wherein a permeability of the drum-core is substantially 60 to 300, and the drum-core is formed by molding magnetic powders, and then sintering it by a temperature above 300° C.

3. The choke coil as claimed in claim 1, wherein a permeability of the drum-core is substantially 60 to 125, and the drum-core is formed by molding magnetic powders, and then sintering it by a temperature above 600° C.

4. The choke coil as claimed in claim 1, wherein the first board and the second board have the same a first diameter and a first thickness, and a second diameter of the pillar is less than the first diameter.

5. The choke coil as claimed in claim 4, wherein the first diameter is substantially 6.6 mm to 23 mm, the first thickness is substantially 0 5 mm to 2.5 mm, the second diameter is substantially 2.2 mm to 9 mm, and a second thickness of the pillar is substantially 1.8 mm to 16.4 mm.

6. The choke coil as claimed in claim 4, wherein a half of a difference between the first diameter and the second diameter is substantially 2.2 mm to 8 mm.

7. The choke coil as claimed in claim 4, wherein a ratio of the first diameter and the second diameter is substantially 2 to 3.

8. The choke coil as claimed in claim 4, wherein a ratio of a second thickness of the pillar and the first thickness is substantially 3 to 7.

9. The choke coil as claimed in claim 1, further comprising:
a magnetic material, filled between the first board and the second board, and encapsulating the winding portion of the wire.

10. The choke coil as claimed in claim 9, wherein the magnetic material comprises a resin material and a magnetic powder material.

11. The choke coil as claimed in claim 9, wherein a permeability of the magnetic material is substantially 5 to 10.

12. The choke coil as claimed in claim 9, wherein a winding space is formed among the first board, the second board and the pillar, and the magnetic material and the winding portion of the wire are located in the winding space.

13. The choke coil as claimed in claim 1, wherein the pillar and the first board are formed integrally, and a bonding layer is formed between the pillar and the second board.

14. The choke coil as claimed in claim 13, wherein a height of the bonding layer is substantially less than 100 micrometers.

15. The choke coil as claimed in claim 1, wherein the pillar has mutually independent a first part and a second part, wherein the first part and the first board are formed integrally, the second part and the second board are formed integrally, and a bonding layer is formed between the first part and the second part.

16. The choke coil as claimed in claim 15, wherein a height of the bonding layer is substantially less than 50 micrometers.

17. The choke coil as claimed in claim 1, wherein an initial inductance of the choke coil is substantially above 2 microhenrys.

18. The choke coil as claimed in claim 1, wherein the ferrous alloy comprises ferro-silicon-aluminium (FeAlSi) alloy, ferro-nickel-molybdenum (FeNiMo) alloy, ferro-nickel (FeNi) alloy or amorphous alloy.

19. The choke coil as claimed in claim 1, wherein the wire is a hollow coil passed through the pillar.

20. The choke coil as claimed in claim 1, wherein the ferrous alloy is substantially a ferro-silicon-aluminium alloy with a permeability of 75 to 125.
